(19) United States
(12) Patent Application Publication
(10) Pub. No.: US 2026/0044421 A1
(43) Pub. Date: Feb. 12, 2026

(54) COMBINED SERIAL AND CONCURRENT FAULT SIMULATION

(71) Applicant: Synopsys, Inc., Sunnyvale, CA (US)

(72) Inventor: Ulrich HOLTMANN, Aachen (DE)

(21) Appl. No.: 18/801,093

(22) Filed: Aug. 12, 2024

(51) Int. Cl. G06F 11/26; G06F 11/22

(52) U.S. Cl. CPC G06F 11/261; G06F 11/221

(57) ABSTRACT

Systems and methods for fault simulation are presented to reduce computation processing. A system includes a memory and a processor, operatively coupled to the memory, to perform fault simulation by injecting a plurality of faults into an IC model, initiating a concurrent fault simulation for all of the plurality of faults injected into the IC model, identifying at least one fault of the plurality of faults that is unable to be implemented by the concurrent fault simulation, and initiating a single fault simulation to process the at least one fault unable to be implemented by the concurrent fault simulation without interrupting the concurrent fault simulation from processing other faults of the plurality of faults. The at least one fault from the concurrent fault simulation is immediately discarded and the fault results from the concurrent fault simulation and the single fault simulation are combined upon completion of both simulations.

### TECHNICAL FIELD

The present disclosure generally relates to fault simulation. More specifically, the present disclosure relates to reducing the computation effort in performing fault simulation by combining serial fault simulation and concurrent fault simulation.

### BACKGROUND

Fault simulation in integrated circuits (ICs) is a process used to test the design of an IC by simulating how the IC would behave in the presence of faults. This is done to ensure the reliability and robustness of the IC before it goes into production. Fault simulation is beneficial in the design and testing of digital and analog ICs, ensuring that the final product is free of defects and operates reliably in real-world conditions. Fault simulation is used in various stages of the IC design process, from initial design verification to final production testing.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a logic simulation with no simulated faults.

FIG. 2A illustrates a serial fault simulation.

FIG. 2B illustrates multiple different serial fault simulations.

FIG. 3 illustrates a concurrent fault simulation.

FIG. 4A illustrates a combination of serial fault simulation and concurrent fault simulation.

FIGS. 4B-4D illustrate using a forked process when combining the serial fault simulations and concurrent fault simulation.

FIG. 5 illustrates a flowchart for combining a concurrent fault simulation with serial fault simulations.

FIG. 6 illustrates a flowchart for combining a concurrent fault simulation with serial fault simulations when multiple programming language interface (PLI) calls are detected from multiple faults.

FIG. 7 illustrates an example computer system in which embodiments of the present disclosure may operate.

FIG. 8 illustrates an example set of processes used during the design, verification, and fabrication of an article of manufacture such as an integrated circuit to transform and verify design data and instructions that represent the integrated circuit.

### DETAILED DESCRIPTION

Aspects of the present disclosure relate to fault simulation, and, in particular, to combining serial fault simulation and concurrent fault simulation to reduce computational processing.

Fault simulation in integrated circuits (ICs) is a process used to test the design of an IC by simulating how the IC would behave in the presence of faults. This is done to ensure the reliability and robustness of the IC before it goes into production. Fault simulation relies on predefined fault models, which represent typical defects that can occur in an IC. Common fault models include stuck-at faults, bridging faults, and open faults. Test vectors are sets of inputs applied to the IC during simulation. The responses of the IC to these inputs are compared with the expected responses to determine if a fault is present. Fault simulation tools inject faults into the IC model and apply the test vectors to see if the faults can be detected. The process involves fault injection, simulation, and analysis. Fault injection involves introducing faults into the IC model based on the fault models, simulation involves running the IC model with the injected faults and test vectors, and analysis involves comparing the simulated outputs with the expected outputs to identify undetected faults.

There are at least two possible types of fault simulations, that is, serial fault simulation and concurrent fault simulation.

Serial fault simulation is a method where faults are simulated one at a time. The process involves injecting a single fault, running the simulation, comparing outputs, and repeating for each fault. In particular, a single fault is introduced into the IC model based on a predefined fault model, the test vectors are applied to the IC model with the injected fault, the outputs of the faulty IC model are compared to the expected correct outputs to determine if the fault is detected, and the above process is repeated for each fault in the fault list. The advantages of serial fault simulation include accuracy and simplicity. Since each fault is simulated individually, the process is straightforward and easy to implement. However, serial fault simulation can be time-consuming and computationally intensive. Simulating faults one at a time is slow, especially for large ICs with many potential faults. The process demands significant computational resources as each fault is simulated separately.

Concurrent fault simulation is a method where multiple faults are simulated simultaneously and independently of each other. This technique aims to balance the accuracy of serial fault simulation with improved speed. The process involves injecting multiple faults, running the simulation, analyzing fault effects, and identifying detected faults. In particular, multiple faults are introduced into the IC model simultaneously, the test vectors are applied to the IC model with all the injected faults, the effects of each fault are tracked concurrently during the simulation, and the outputs are analyzed to determine which faults are detected by the test vectors. The advantages of concurrent fault simulation include speed and efficiency. Simulating multiple faults at once significantly reduces the overall simulation time and a large number of faults can be handled more efficiently than serial fault simulation. However, concurrent fault simulation can be complex and has limitations. The implementation is more complex as it involves sophisticated algorithms to track and analyze the effects of multiple faults simultaneously, and, depending on the method used, there may be some trade-offs compared to serial fault simulation. For example, concurrent fault simulation offers higher performance through parallelism but at a cost of increased complexity and resource consumption. Concurrent fault simulation maximizes the use of available computational resources but can lead to high memory usage and overhead from parallel execution. Concurrent fault simulation provides a more comprehensive analysis by evaluating multiple faults simultaneously but can be limited by hardware constraints.

Therefore, serial fault simulation focuses on simulating each fault independently. However, it is slower and computationally intensive. Concurrent fault simulation aims to improve speed and efficiency by simulating multiple faults simultaneously. However, it is more complex to implement and might have slight trade-offs.

The example embodiments provide for a method and system for combining serial fault simulation and concurrent fault simulation. All the faults are initially processed using a concurrent fault simulation. When a specific fault of all the faults reaches a limitation, such as a programming language interface (PLI) call (or call function), a new simulation process is created. The new simulation process is a single fault simulation process. The identified fault that is unable to be processed or implemented by the concurrent fault simulation is discarded from the concurrent fault simulation and switched or transitioned to the single fault simulation. The concurrent fault simulation does not experience any interruptions by the switch-over or transition. When the identified fault transitions from the concurrent fault simulation to the single fault simulation, the identified fault inherits its processing state from a point of transition. The identified fault is processed by the new single fault simulation until, e.g., the fault is detected. Once the fault in the single fault simulation is detected and the faults of the concurrent fault simulation are detected, the results are combined and provided to a user for further analysis.

Combining serial fault simulation and concurrent fault simulation to create a hybrid approach can leverage the strengths of both methods, providing a more efficient and effective fault simulation process. By focusing on serial simulation on critical areas and using faster concurrent simulation for other areas, computational resources can be utilized more effectively. This balance allows for the thorough testing of large ICs without excessive computing resource consumption. Combining both approaches can help achieve higher fault coverage by ensuring that all types of faults are effectively simulated and detected. The hybrid approach can cover a broader range of fault models and scenarios, enhancing the reliability of the IC. The hybrid approach can be adapted to different stages of the design process. The hybrid approach is scalable, making it suitable for small IC designs as well as large, complex systems.

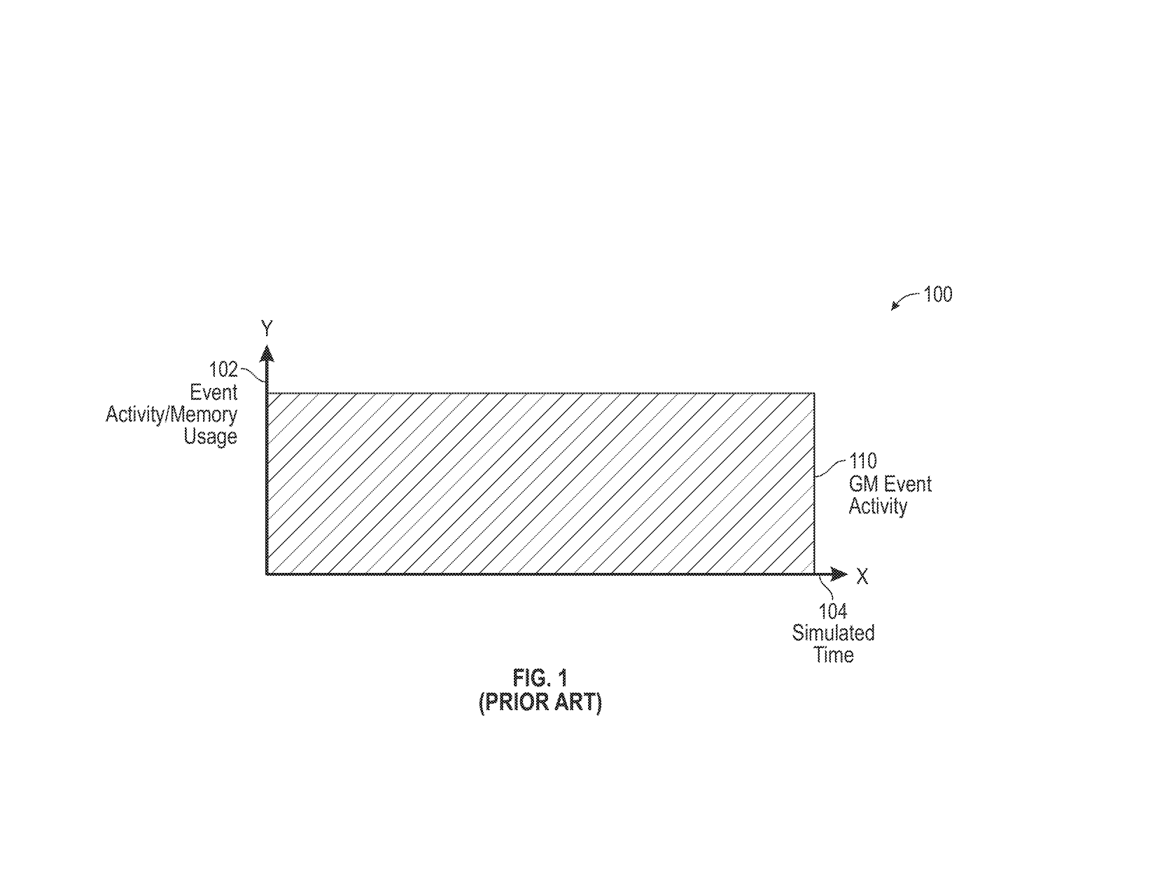

FIG. 1 illustrates a logic simulation with no simulated faults.

The logic simulation 100 is graphically shown as an event activity in a region 110. The x-axis represents the simulated time 104 and the y-axis represents the event activity or memory usage 102. The basis for fault simulation is the logic simulation 100 of the event-driven simulator (i.e., event activity) for hardware description languages, such as Verilog or VHDL (VHSIC hardware description language). In the examples, the behavior of the logic simulation 100 is referred to as a good machine (GM). The term “good machine” indicates that there are no faults in the IC and that the IC or machine are operating properly. The event activity in the region 110 may also be referred to as a GM event activity. The computation effort of the GM event activity is proportional to the number of simulation events. Stated differently, the CPU time of an event-driven simulation is proportional to the number of events that are simulated.

For example, the input value of one input of a XOR gate can change from logic 0 to logic 1. This value change event involves re-computation of the value of the output of the XOR gate, and in case it is a different value than before, the new value is propagated to all the gated connected to that output port.

A logic simulation is a process used in the design and verification of digital circuits. Logic simulation involves creating a model of a digital circuit and testing its behavior using simulation software before physically fabricating the circuit. The primary goal is to ensure that the circuit design functions correctly according to its specifications and requirements. Logic simulation with no faults involves the process of verifying the functional correctness of a digital circuit design by simulating its behavior without considering any potential faults or defects. This type of simulation is beneficial in the early stages of design to ensure that the circuit performs as intended under ideal conditions.

There are different types of logic simulations, such as, functional simulations, timing simulations, and gate-level simulations. Functional simulation focuses on verifying that the design performs the correct operations as specified, without considering timing, timing simulation includes timing information to verify that the design meets timing constraints and behaves correctly under real-world conditions, and gate-level simulation simulates the design at the gate level to ensure that the synthesis process has not introduced errors. Any type of logic simulation may be represented by the logic simulation 100.

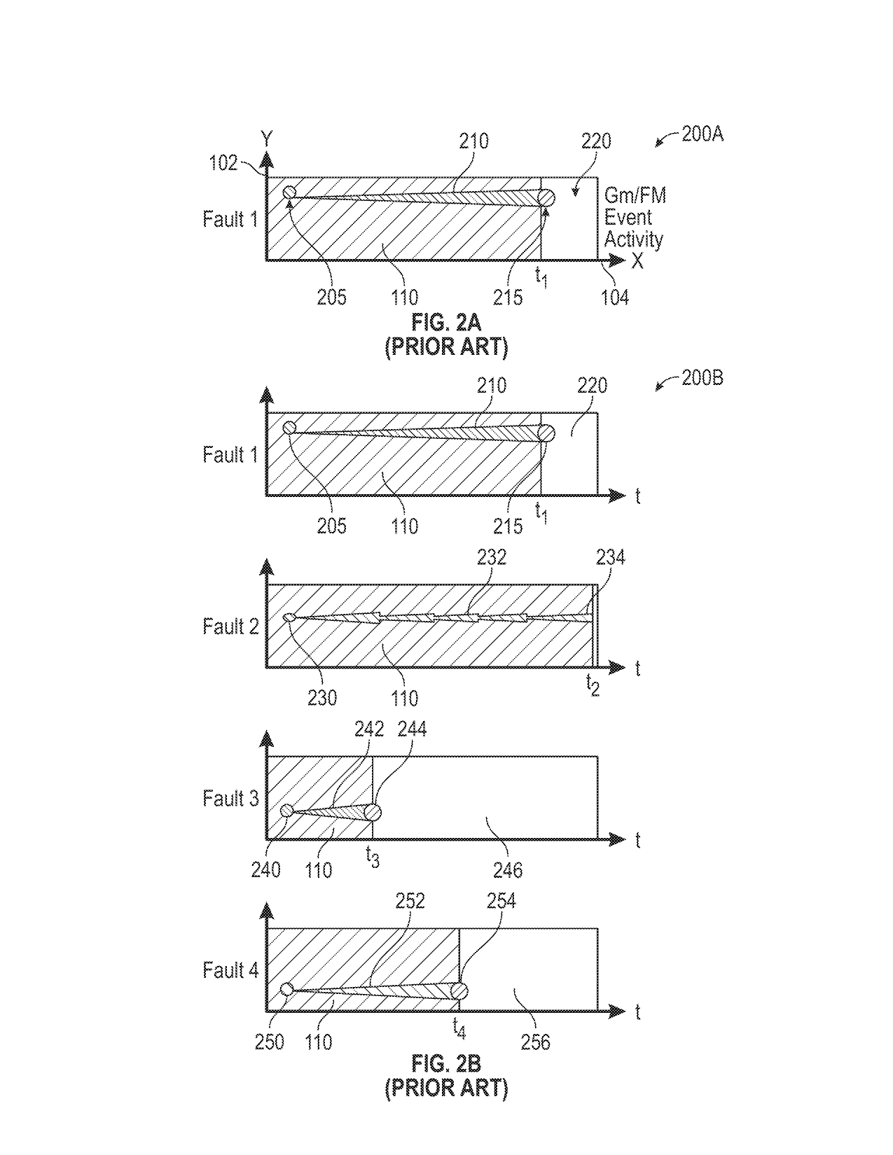

FIG. 2A illustrates a serial fault simulation.

Serial fault simulation simulates each fault as a separate simulation process. A fault is simulated by injecting the fault-specific semantics on top of the simulation model and then allowing the simulation to continue until the default is detected or the simulation ends. Injecting the fault turns the GM into a faulty machine (FM). The term “faulty machine” indicates that a fault has been injected into the IC. The computation effort of a serial fault simulation is, at average, the same as the underlying logic simulation.

The schematic 200A illustrates a first fault 205 injected or introduced into the IC model based on a predefined fault model. The injection of a fault changes the behavior of the simulation and turns the GM to an FM. In other words, the FM = GM + the first fault 205. For most events and internal states, the GM and the FM are the same or identical. This is depicted in region 110. The cone of impact (COI) 210 is an event activity when internal states or events in the fault simulation deviate from the GM logic simulation. The COI 210 may refer to the temporal and spatial extent of fault impact. The COI 210 is typically small. At point t₁, the injected fault is detected. The fault detection point 215 indicates the end of the region 110, as fault processing ends. The COI 210 extends between the injection point and the detection point, that is, the first fault 205 and the fault detection point 215. Once the fault is detected, there is no need to simulate GM events in the region 220.

Simulating a single fault demands, on average, computing the same number of events as a logic simulation, and sometimes fewer if the fault is detected early. Moreover, simulating all N faults involves N times the effort because N individual simulations are performed. In other words, each fault involves a separate and distinct simulation. Additionally, when processing faults individually, there is no memory sharing.

FIG. 2B illustrates multiple different serial fault simulations 200B.

A first fault 205 is injected or introduced into the IC model based on a predefined fault model. The injection of the first fault 205 changes the behavior of the simulation and turns the GM to FM1. In other words, the FM1 = GM + the first fault 205. At point t₁, the injected fault is detected. The fault detection point 215 indicates the end of the region 110, that is, the fault processing region. The COI 210 extends between the injection point and the detection point, that is, the first fault 205 and the fault detection point 215. Once the first fault 205 is detected, there is no need to simulate GM events in the region 220.

A second fault 230 is injected or introduced into the IC model based on a predefined fault model. The injection of the second fault 230 changes the behavior of the simulation and turns the GM to FM2. In other words, the FM2 = GM + the second fault 230. At point t₂, the injected fault is still not detected. The fault end point 234 indicates the end of the region 110. The fault end point 234 indicates that the second injected fault was not detected within the allotted time frame and the simulation timed out at that point. The cone of impact 232 extends between the injection point and the fault end point 234 (where detection of the second fault was not realized).

A third fault 240 is injected or introduced into the IC model based on a predefined fault model. The injection of the third fault 240 changes the behavior of the simulation and turns the GM to FM3. In other words, the FM3 = GM + the third fault 240. At point t₃, the injected fault is detected. The fault detection point 244 indicates the end of the region 110. The cone of impact 242 extends between the injection point and the detection point, that is, the third fault 240 and the fault detection point 244. Once the third fault 240 is detected, there is no need to simulate GM events in the region 246.

A fourth fault 250 is injected or introduced into the IC model based on a predefined fault model. The injection of the fourth fault 250 changes the behavior of the simulation and turns the GM to FM4. In other words, the FM4 = GM + the fourth fault 250. At point t₄, the injected fault is detected. The fault detection point 254 indicates the end of the region 110. The cone of impact 252 extends between the injection point and the detection point, that is, the fourth fault 250 and the fault detection point 254. Once the fourth fault 250 is detected, there is no need to simulate GM events in the region 256.

In one example, when the first serial fault simulation for the first fault ends, the second serial fault simulation for the second fault ends, the third serial fault simulation for the third fault ends, and the fourth serial fault simulation for the fourth fault ends, the fault results of each of the serial fault simulations may be combined with the fault results of the concurrent fault simulation. The first, second, third, and fourth serial fault simulations may be referred to as forked simulations, as they use a fork function, as described below. The fork function may be a UNIX fork function. However, a fork function from any other type of operation system may also be employed or any other means of duplicating the simulation process, for example with save+restore functionality of the simulator. Thus, any means of copying the process may be employed. This can be referred to as forking the process or cloning the process or copying the process. This may involve any copy process that takes process P, creates a new process P’ that has an identical internal state as P, and the starts running at the point where P was when P’ was created. For example, in Linux, a clone function may be used and in Windows, a spawn function may be used. The UNIX fork function is merely an illustrative, non-limiting example.

Thus, the systems and methods allow faults that hit certain limitations (e.g., call functions) to be separately processed in individual simulation processes. Such faults are removed from the concurrent fault simulation without affecting the operation of the concurrent fault simulation. Thus, the concurrent fault simulation can process hundreds of fault simulations simultaneously while offloading certain event simulations to single fault simulations.

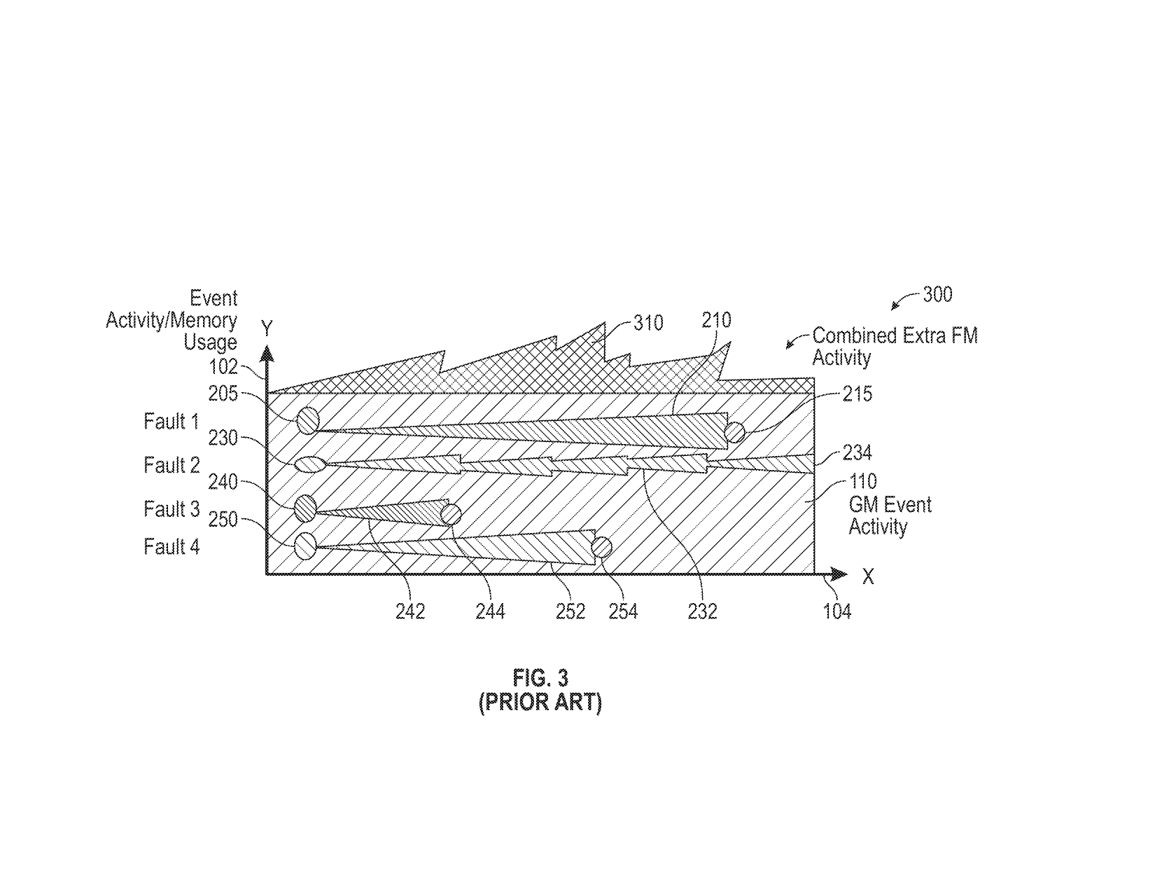

FIG. 3 illustrates a concurrent fault simulation.

Concurrent fault simulation simulates multiple faults (or multiple FMs) in the same simulation process, where event processing of one FM does not interfere with other FMs or with the GM. Each FM typically adds only a small incremental computational effort to the underlying GM. For example, if 1 million faults are to be simulated, a serial fault simulation involves 1 million simulation processes to run. However, concurrent fault simulation may combine 2000 faults per simulation and thus involves only 500 simulation processes to be run. As such, concurrent fault simulation is more efficient than serial fault simulation. However, concurrent fault simulation has other limitations, where programming language interface (PLI) calls or SV class method calls may not be functionally processed in the context of an FM. Such calls may occur at any time within the simulation and involve dropping or discarding the fault from the concurrent fault simulation and simulate it at a later time with a serial fault simulation.

A PLI call refers to a set of extensions or hooks that allow users to integrate custom C or C++ code with hardware description language (HDL) simulators, such as those for Verilog or VHDL. This interface provides a way to enhance and extend the capabilities of the simulator, enabling more sophisticated fault simulation and analysis techniques that might not be natively supported by the simulator itself. The PLI call is permitted to call external functions written in C or C++ from within, e.g., a Verilog module.

The schematic 300 illustrates the first fault 205, the second fault 230, the third fault 240, and the fourth fault 250 concurrently or simultaneously injected or introduced into the IC model based on a predefined fault model. Multiple FMs are run on top of the GM. Each FM computes only the events where the FM behavior deviates from the GM behavior. In other words, only the events within the cone of impact are computed per FM. Because the cones of impact are typically small compared to the overall GM, each FM adds only a small increase in the overall event activity. The computational effort for N concurrent faults is thus typically smaller than simulating N faults serially with N different simulations.

The first fault 205 is detected as the fault detection point 215 and the COI 210 is identified. The second fault 230 is not detected by the fault end point 234 and a cone of impact 232 is identified. The third fault 240 is detected as the fault detection point 244 and a cone of impact 242 is identified. The fourth fault 250 is detected as the fault detection point 254 and a cone of impact 252 is identified. The cones of influence are identified within the region 110. In one example, thousands of faults may be simultaneously simulated. Thus, N fault machines (FM) are run concurrently. In this example, there are four fault machines, that is, FM1, FM2, FM3, and FM4. The cone of impact for each fault is different, as the fault is detected at different points of fault processing. The combined FM activities 310 are illustrated over the region 110.

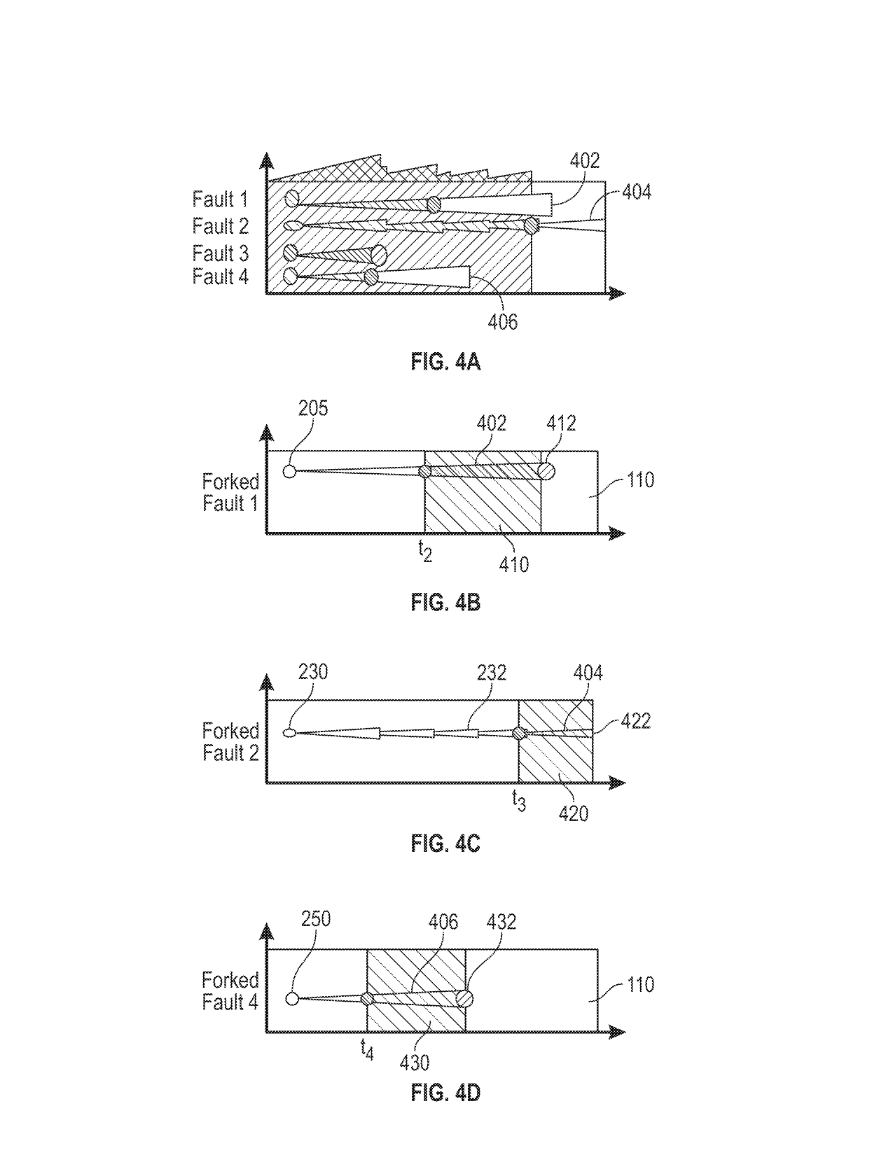

FIG. 4A illustrates a combination of serial fault simulation and concurrent fault simulation and FIGS. 4B-4D illustrate using a forked process when combining the serial fault simulations and concurrent fault simulation.

In FIG. 4A, the first fault 205, the second fault 230, the third fault 240, and the fourth fault 250 are injected at the same time into an IC model. Thus, concurrent fault simulation is performed on all the injected faults. Each of the four faults has its own cone of impact slowly expanding. Some injected faults are detected, while other injected faults may not be detected within an allotted simulation time frame. Even though four faults are illustrated, it is understood that hundreds and even thousands of faults may be simultaneously processed by the concurrent fault simulation.

In FIG. 4B, at time t₂, e.g., a PLI call is encountered or identified for the first fault 205. The PLI call first gets initiated in the concurrent fault simulation in FIG. 4A. The PLI call is a simulation event that cannot be properly handled or is unable to be handled or processed or implemented by the concurrent fault simulation process. Examples of challenging simulation events may include, e.g., interdependent fault effects, sequential dependencies, resource contention events, complex dependency chains, and intra-fault dependencies. For example, regarding interdependent fault effects, when faults interact in a non-linear or complex manner, the effects of one fault may depend on the presence or behavior of another fault. Concurrent fault simulation may struggle to accurately model such dependencies, as concurrent fault simulation typically assumes faults can be analyzed in isolation or with limited interaction. For example, regarding sequential dependencies, in circuits with significant state dependencies, the state changes caused by one fault may affect the behavior of subsequent faults in ways that are difficult to parallelize. Some faults that have time-dependent interactions, where the occurrence of one fault at a specific time affects the outcome of another fault later in time, may be more accurately simulated using sequential processing. For example, regarding resource contention, when faults affect shared resources, concurrent fault simulation can lead to contention issues that are difficult to resolve in parallel. The simulation needs to account for mutual exclusion and timing of resource access, which may be challenging to model concurrently. Additionally, in another example regarding complex dependency chains, faults can lead to a cascade of dependent faults, where the occurrence of one fault triggers another, which in turn triggers more faults, which can be difficult to parallelize. Each fault in the chain may need to be processed sequentially to accurately capture the cascading effects. Thus, such simulation event instances may not be properly handled or processed by concurrent fault simulation.

As such, the first fault 205 is forked off as a separate process. In other words, the second fault 230, the third fault 240, and the fourth fault 250 continue to be processed in a concurrent fault simulation whereas a new simulation process (i.e., a serial fault simulation process) is commenced for the first fault 205. The concurrent fault simulation process for the second fault 230, the third fault 240, and the fourth fault 250 may be designated as P and the serial fault simulation process for the first fault 205 may be designated as P’. The first fault 205 is also immediately dropped from the concurrent fault simulation process P. Also, the new simulation process, that is, the serial fault simulation process inherits the state from the concurrent fault simulation process and immediately re-configures itself to focus only on the first fault 205. Therefore, the serial fault simulation process only handles the first fault 205.

As such, the serial fault simulation process for the first fault 205 commences at time t₂, immediately upon detecting the PLI call. In the serial fault simulation process or forked process, the PLI call is detected at detection point 412. A second cone of impact (COI) 402 starts and expands from time t₂. The second COI 402 extends from where the PLI call was detected in the concurrent fault simulation to where the PLI call was detected in the serial fault detection, designated as region 410, which is proportional to the simulation time in the logic simulation. Thus, a forked process is presented for handling a PLI call for the first FM or FM1. The serial fault simulation process inherits the simulation state of the PLI call (e.g., the entire GM and all FMs), and drops all the FMs except for FM1 (i.e., the first fault 205). The specific state of the FM1 is forced into the GM. The fault injection point remains as FM1. The serial fault simulation process commences and ends when the FM1 (or PLI call) is detected. When the concurrent fault simulation process and the serial fault simulation process both end, all the results are combined. In other words, the results of the concurrent fault simulation process and the results of all the forked-off processes are combined and presented to a user for analysis.

Combining and presenting the results from serial and concurrent fault simulation involves careful consideration to ensure accuracy and usability. The steps for combining the results may include, e.g., data collection, normalization and synchronization, data integration, error analysis, and result presentation. Data collection may involve collecting results from the concurrent fault simulation, which will typically include fault coverage, timing information, and the impact of faults on circuit behavior. Data collection may involve collecting results from the serial fault simulation ensuring the detailed dependencies and interactions between faults are accurately captured. The results may then be normalized into a common format. This might involve converting the data structures so that both sets of results can be compared and combined easily. The results may also be synchronized in terms of timing and fault identification. The results may be integrated by merging fault coverage data, error logs, and performance metrics. This can involve creating composite datasets that include information from both simulations. Additionally, any conflicts between the datasets may be addressed and resolved. For error analysis, the results from the serial fault simulation may be used to validate and refine the results from the concurrent fault simulation. This can help identify any discrepancies and improve the accuracy of the final results. After error analysis is performed, a unified report may be created that presents the combined results in a clear and concise manner. The report may include a summary of the total fault coverage achieved by both simulations, detailed information on each fault, comparative performance metrics showing the time taken and resources used by both simulation approaches, and graphs and/or charts to illustrate the fault coverage, timing analysis, and other relevant data.

A user interface may be employed with interactive dashboards and annotations. The results may be presented through an interactive dashboard that allows users to explore the data. Users should be able to filter the results, pinpoint specific faults, and view comparative analyses. The results may be further annotated to highlight significant findings, such as faults with complex dependencies or those with high impact on circuit performance.

Additionally, the first fault 205 inherits the state of the process. In other words, the first fault 205 inherits its state from the point of transition. The processing of the first fault 205 does not start over when the PLI call is detected. Instead, the processing continues from the point of detection of the PLI call (which is the point from where the first fault 205 transitions from the concurrent fault simulation to the single fault simulation). Thus, when the first fault 205 transitions from the concurrent fault simulation to the single fault simulation, its previous process is copied. Stated differently, the first fault 205 is not re-processed from the point of injection. Instead, the processing continues from the point of transition or the point of detection of the PLI call (as the single fault simulation process is re-configured to only process the first fault 205). Similarly, the second fault 230 inherits its state from the point of transition and is copied to the single transition simulation without any re-processing, as described below.

A PLI call may be detected during processing of the other faults. As such, multiple faults may be forked off to separate and individual single fault simulations.

In FIG. 4C, at time t₃, e.g., a PLI call is encountered or identified for the second fault 230. The PLI call is a simulation event that cannot be properly handled or is unable to be handled or processed or implemented by the concurrent fault simulation process. As such, the second fault 230 is forked off as a separate process. In other words, the third fault 240 and the fourth fault 250 continue to be processed in a concurrent fault simulation whereas a new simulation process (i.e., a serial fault simulation process) is commenced for the second fault 230. It is noted that the first fault 205 remains forked off in its own serial fault simulation process. Thus, there are now two separate and distinct forked processes each re-configured to handle only one fault.

Therefore, at t₂, the first fault 205 is forked off into a first serial fault simulation process and at time t₃, the second fault is forked off into a second serial fault simulation process. The first serial fault simulation process only handles the first fault 205 and the second serial fault simulation process only handles the second fault 230. Thus, the first serial fault simulation is re-configured to handle only the first fault 205 and the second serial fault simulation is re-configured to handle only the second fault 230. As such, multiple serial fault simulations may be performed, one for each fault that cannot be handled or is unable to be properly handled or processed or implemented by the concurrent fault simulation.

The second fault 230 is immediately dropped from the concurrent fault simulation process upon detection of the PLI call. In this example, the PLI call was not detected within the allotted simulation time frame by the end detection point 422. The second cone of impact 404 extends from where the PLI call was injected in the concurrent fault simulation to the end detection point 422, designated by region 420, which is proportional to the simulation time in the logic simulation. Thus, a forked process is presented for handling a PLI call for the second FM or FM2. The serial fault simulation process inherits the simulation state of the PLI call (e.g., the entire GM and all FMs), and drops all the FMs except for FM2 (i.e., the second fault 230). The specific state of the FM2 is forced into the GM. The fault injection point remains as FM2. The serial fault simulation process ends when the FM2 (or PLI call) is not detected within an allotted time frame.

Additionally, the second fault 230 inherits the state of the process. In other words, the second fault 230 inherits its state from the point of transition. The processing of the second fault 230 does not start over when the PLI call is detected. Instead, the processing continues from the point of detection of the PLI call (which is the point from where the second fault 230 transitions from the concurrent fault simulation to the single fault simulation). Thus, when the second fault 230 transitions from the concurrent fault simulation to the single fault simulation, its previous process is copied. Stated differently, the second fault 230 is not re-processed from the point of injection. Instead, the processing continues from the point of transition or the point of detection of the PLI call (as the single fault simulation process is re-configured to only process the second fault 230).

In FIG. 4D, at time t₄, e.g., a PLI call is encountered or identified for the fourth fault 250. The PLI call is a simulation event that cannot be properly handled or is unable to be handled or processed or implemented by the concurrent fault simulation process. As such, the fourth fault 250 is forked off as a separate process. The fourth fault 250 is immediately dropped from the concurrent fault simulation process upon detection of the PLI call. The fourth cone of impact 406 extends from where the PLI call was detected in the concurrent fault simulation to where the PLI call was detected in the serial fault detection, designated as region 430, which is proportional to the simulation time in the logic simulation. The PLI call is detected at detection point 432. The handling of the fourth fault 250 is similar to the handling of the first fault 205 described above.

Additionally, the fourth fault 250 inherits the state of the process. In other words, the fourth fault 250 inherits its state from the point of transition. The processing of the fourth fault 250 does not start over when the PLI call is detected. Instead, the processing continues from the point of detection of the PLI call (which is the point from where the fourth fault 250 transitions from the concurrent fault simulation to the single fault simulation). Thus, when the fourth fault 250 transitions from the concurrent fault simulation to the single fault simulation, its previous process is copied. Stated differently, the fourth fault 250 is not re-processed from the point of injection. Instead, the processing continues from the point of transition or the point of detection of the PLI call (as the single fault simulation process is re-configured to only process the fourth fault 250).

According to FIGS. 4B-4D, when the serial fault simulation of the first fault 205 ends, that is, the PLI call is detected at detection point 412, FM1 ends, and the process enters GM or region 110. When the serial fault simulation of the second fault 230 ends, that is, the PLI call is not detected by the end detection point 422, FM2 ends, and the process enters GM or region 110. When the serial fault simulation of the fourth fault 250 ends, that is, the PLI call is detected at detection point 432, FM4 ends, and the process enters GM or region 110. Therefore, when each of the forked-off processes ends, all the results from the forked off processes are combined with the results from the concurrent fault simulation process. In this example, the fault results include detecting the first fault 205 and the fourth fault 250 during the simulation time frame and not detecting the third fault 240 during the simulation time frame. These individual results are combined with the multitude of fault results from the concurrent fault simulation.

As a result, any simulation events that cannot be properly processed or are unable to be processed or handled or implemented by the concurrent fault simulation process are forked off into separate serial fault simulation processes. Thus, instead of dropping the fault when encountering a limitation (e.g., a call function), the fault is forked off to a new single fault simulation. Several serial fault simulations may be performed simultaneously or concurrently with the concurrent fault simulation process.

The “fork function” in the UNIX operating system is a system call used to create a new process. The new process created by fork is called the child process, and the process that called “fork” is the parent process. The key aspects and behaviors of the fork function include process duplication, return values, independent execution, copy-on-write, and process management. When “fork” is called, it creates a duplicate of the parent process. The child process is an exact copy of the parent process, including the program counter, process stack, heap, and data segments. The fork function returns a different value to each process. After the fork, the parent and child processes can execute independently. They have separate memory spaces, although initially, they are copies of each other. Any changes made to the memory space of one process do not affect the other. Modern UNIX systems use a technique called copy-on-write to optimize memory usage. Instead of copying the entire memory space of the parent process immediately, both processes share the same memory pages until one of them modifies a page. Only then is the page copied. The parent process can control the child process using various process management system calls such as “wait” and “exec.”

Regarding FIGS. 4A-4D, reducing computational effort or processing requirements in terms of CPU and memory usage has several significant advantages.

Regarding CPU utilization, reduced computation processing results in improved performance, energy efficiency, increased scalability, and cost savings. Improved performance includes faster execution and reduced latency. Lower computational effort leads to faster execution times, enhancing the overall performance of applications and systems. Minimizing CPU load helps in reducing the response time of real-time systems and applications, improving user experience. Improved energy efficiency includes lower power consumption and heat reduction. Efficient CPU usage leads to lower power consumption, which is especially useful for battery-powered devices like laptops, smartphones, and Internet-of-Things (IoT) devices. Reduced CPU load generates less heat, which can enhance the longevity of the hardware and reduce the need for cooling mechanisms. Increased scalability includes handling more tasks and better resource allocation. Efficient CPU utilization allows systems to handle more concurrent tasks or users, increasing the scalability of servers and cloud services. Freeing up CPU resources enables better allocation to other critical processes, thus improving overall system efficiency. Cost savings include reduced operational and hardware costs. Lower energy consumption reduces electricity bills, and less frequent cooling reduces operational costs for data centers. Efficient use of existing hardware can delay the need for expensive hardware upgrades or expansions.

Regarding memory utilization, reduced computation processing results in enhanced performance, better energy efficiency, increased system stability, and cost savings. Enhanced performance includes faster access and improved multitasking. Reducing memory usage can decrease the need for swapping data in and out of disk storage, leading to faster data access and overall system performance. Lower memory usage allows for more applications to run concurrently without performance degradation. Energy efficiency includes lower power consumption and heat reduction. Efficient memory usage reduces the power used to maintain and access memory, contributing to overall energy efficiency. Similar to the CPU, efficient memory usage generates less heat, reducing cooling requirements and improving hardware longevity. Increased system stability includes avoiding memory leaks and enhanced reliability. Efficient memory management helps in avoiding memory leaks and related issues, which can lead to system crashes or slowdowns. Systems with optimized memory usage are less likely to encounter out-of-memory errors, leading to higher reliability and uptime. Cost savings include reduced operational and hardware costs. Optimized memory usage can extend the life of existing hardware, reducing the need for costly memory upgrades. Lower energy and cooling requirements contribute to reduced operational expenses.

Overall benefits of reducing computational effort or processing requirements in terms of CPU and memory usage include reduction in environmental impact, enhanced user experience, flexibility and adaptability, and providing competitive advantage. Lower power consumption and reduced cooling needs contribute to a smaller environmental footprint, aligning with sustainable and green computing practices. Efficient use of CPU and memory resources reduces electronic waste by prolonging hardware lifespan. Applications and systems with optimized resource usage are more responsive, providing a better user experience. Efficient systems are less prone to crashes and slowdowns, ensuring a smoother and more reliable user experience. Systems with lower resource requirements can be deployed on a wider range of hardware, including low-power and embedded systems. Efficient resource usage ensures that systems can handle future increases in workload or data without demanding immediate upgrades. Products and services that are more efficient can offer better performance, longer battery life, and lower operating costs, providing a competitive edge in the market. Freed-up resources can be redirected towards innovative features and improvements, driving continuous product and service enhancements. Therefore, by reducing computational effort in terms of CPU and memory usage, systems can achieve higher performance, better efficiency, and significant cost savings, all while providing a more reliable and improved user experience.

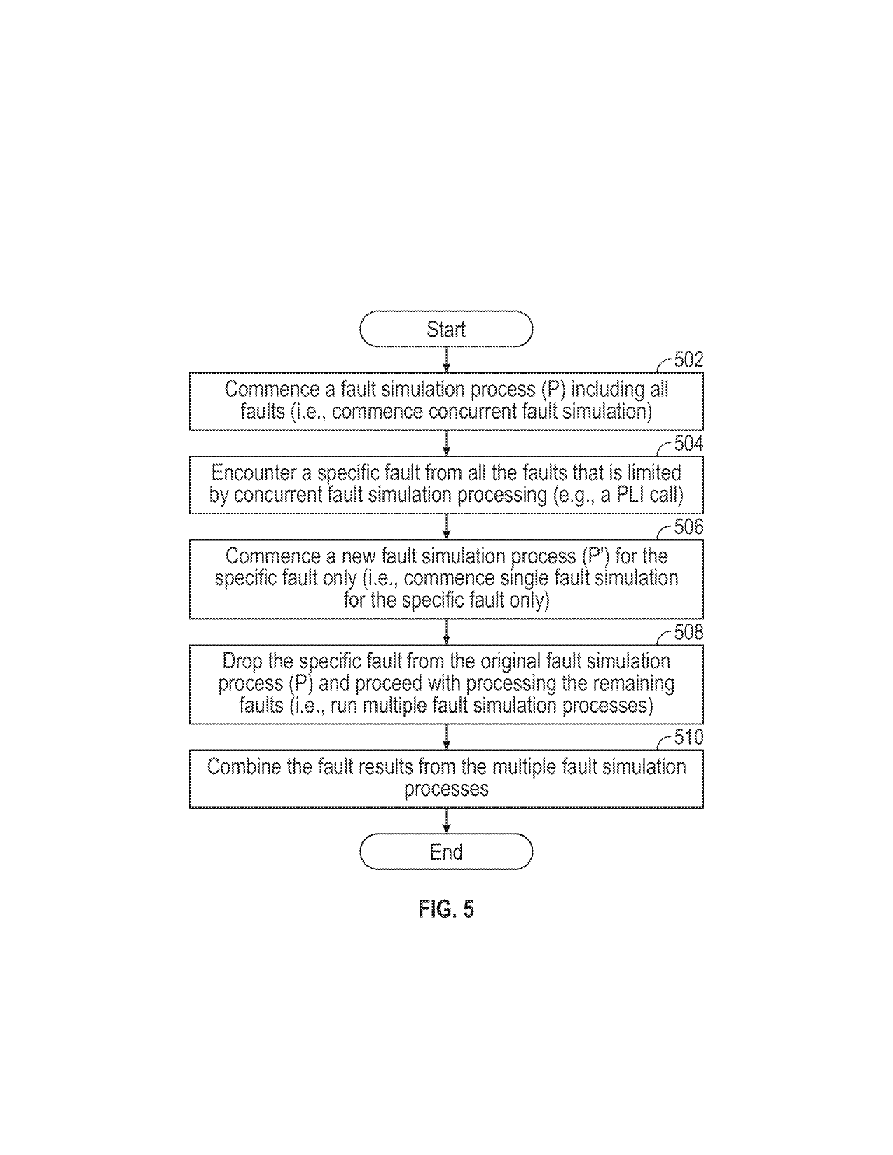

FIG. 5 illustrates a flowchart for combining a concurrent fault simulation with serial fault simulations.

At block 502, a fault simulation process (P) including all faults is commenced. That is, concurrent fault simulation is initiated. In concurrent fault simulation, all the faults are concurrently simulated.

At block 504, a specific fault from all the faults is encountered or identified that is limited by concurrent fault simulation processing (e.g., a PLI call). The concurrent fault simulation is maintained as long as possible. The concurrent fault simulation hits its limitation with certain simulation events, such as, e.g., PLI calls. Stated differently, the concurrent fault simulation may not be able to handle or process the call function.

At block 506, a new fault simulation process (P’) is commenced for the specific fault only (i.e., commence single fault simulation for the specific fault only). The first fault is switched over from the concurrent fault simulation to a single fault simulation. This switch-over occurs as late as possible in the concurrent simulation process. The switch-over may be accomplished by using an operating system fork function. The operating system may be the UNIX system. Alternatively, the switch-over may also be accomplished by saving the state of P on one host, then starting process P’ on the same or another host and restoring the saved state in P’. Any means or method to copying a process (e.g., UNIX fork, process state save/restore, etc.) can be applied. The UNIX fork is an illustrative, non-limiting example.

At block 508, the specific fault from the original fault simulation process (P) is dropped or discarded and the remaining faults are processed (i.e., run multiple fault simulation processes). As such, the specific fault is only processed one time. The concurrent fault simulation continues with the remaining faults without interruption.

At block 510, the fault results from the multiple fault simulation processes are combined. In other words, the fault result from the single fault simulation and the fault results from the concurrent simulation process are combined and presented to a user for further analysis.

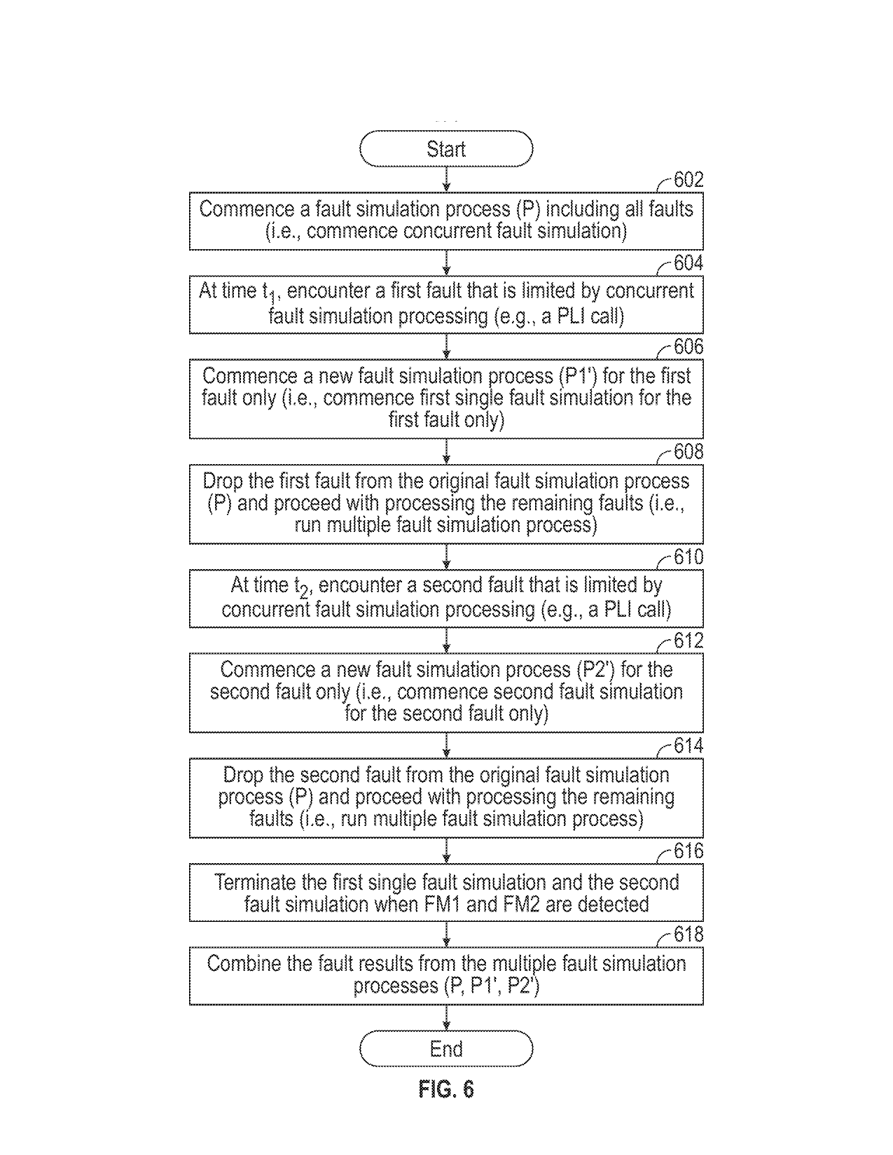

FIG. 6 illustrates a flowchart for combining a concurrent fault simulation with serial fault simulations when multiple PLI calls are detected from multiple faults. The PLI calls may be referred to as PLI functions for calling external functions written in C or C++ from a written Verilog module.

At block 602, a fault simulation process (P) including all faults is commenced. That is, concurrent fault simulation is initiated. In concurrent fault simulation, all the faults are concurrently simulated. Concurrent fault simulation speeds up the testing process.

At block 604, at time t₁, a first fault that is limited by concurrent fault simulation processing (e.g., a PLI call) is encountered or identified. The PLI call is initiated within the cone of influence of a specific FM and would disrupt the concurrent fault simulation processing. In certain typical cases, the fault may be dropped or discarded from the concurrent fault simulation processing.

At block 606, a new fault simulation process (P1’) is commenced for the first fault only (i.e., commence first single fault simulation for the first fault only). The first fault is transitioned from the concurrent fault simulation to a newly generated single fault simulation. The single fault simulation is re-configured to only process the first fault.

At block 608, the first fault is dropped or discarded from the original fault simulation process (P) and the remaining faults are processed (i.e., run multiple fault simulation process).

At block 610, at time t₂, a second fault that is limited by concurrent fault simulation processing (e.g., a PLI call) is encountered or identified. The PLI call is initiated within the cone of influence of a specific FM and would disrupt the concurrent fault simulation processing. In certain typical cases, the fault may be dropped or discarded from the concurrent fault simulation processing.

At block 612, a new fault simulation process (P2’) is commenced for the second fault only (i.e., commence second fault simulation for the second fault only). The second fault is transitioned from the concurrent fault simulation to a newly generated single fault simulation. The single fault simulation is re-configured to only process the second fault. As such, there are now two separate and distinct single fault simulations, each re-configured to process only one individual fault.

At block 614, the second fault is dropped or discarded from the original fault simulation process (P) and the remaining faults are processed (i.e., run multiple fault simulation process). As such, each time a fault hits a limitation, each fault will be switched over to a separate single fault simulation.

At block 616, the first single fault simulation and the second fault simulation are terminated when FM1 and FM2 are detected. Once the respective faults are detected in the respective serial fault simulations, the serial fault simulations are ended, and the process awaits the end of the concurrent fault simulation.

At block 618, the fault results from the multiple fault simulation processes (P, P1’, P2’) are combined. In other words, the fault result from the first serial fault simulation, the second serial fault simulation, and the fault results from the concurrent simulation process are combined and presented to a user for further analysis.

In one example, multiple serial fault simulations may take place concurrently with the concurrent fault simulation. Combining multiple single serial fault simulations with a concurrent fault simulation involves leveraging the strengths of both approaches to efficiently and comprehensively test digital circuits for faults. The example systems and methods dynamically switch certain faults to individual serial fault simulations based on the complexity and criticality of the faults, as well as the type of faults.

According to FIGS. 5 and 6, reducing the computational effort demanded of fault simulations is valuable for enhancing efficiency, speeding up the design process, and lowering costs. The benefits of reducing computational effort include faster design cycle, cost savings, improved productivity, enhanced reliability, scalability, and reduced environmental impact.

In particular, reducing the computational effort accelerates the fault simulation process, leading to faster design iterations and shorter overall design cycles. This allows for quicker time-to-market. Lower computational requirements translate to a reduced need for expensive computing resources, lowering the overall cost of the design and testing process. Reduced simulation times also mean less expenditure on energy and infrastructure. Engineers can focus more on design and optimization rather than waiting for lengthy simulations to complete. This leads to increased productivity and more innovative design solutions. Faster simulations enable more thorough testing and refinement within the same time frame. Efficient fault simulations allow for more extensive testing within the same time constraints, improving the likelihood of detecting and correcting faults early in the design process. Higher reliability in the final product reduces the risk of costly recalls and failures in the field. Reduced computational effort makes it feasible to handle larger and more complex IC designs. This scalability is beneficial as IC designs continue to grow in complexity and size. Efficient simulation techniques can be scaled up to handle future challenges without a proportional increase in resource requirements. Moreover, lowering the computational effort reduces the energy consumption associated with extensive fault simulations, contributing to a smaller environmental footprint. Efficient use of resources aligns with sustainable practices and reduces the carbon footprint of the design process.

In summary, combining serial fault simulation and concurrent fault simulation can leverage the strengths of both methods, providing a more efficient and effective fault simulation process. The benefits of combining these two approaches include enhanced speed, resource optimization, flexibility and adaptability, improved fault detection, cost-effective testing, and process optimization.

Enhanced accuracy and speed provide for improved fault coverage. By starting with concurrent fault simulation to quickly identify faults and then using serial fault simulation to verify and analyze critical faults in detail, improved fault detection results may be achieved. Concurrent fault simulation can quickly cover a large number of faults, while serial simulation can ensure that faults reaching limitations of concurrent fault simulation are handled and can be detected.

Resource optimization involves efficient use of computational resources and scalability. Concurrent fault simulation can be used to handle the bulk of faults, reducing the overall simulation time. Serial fault simulation can then be applied selectively to specific faults, optimizing the use of computational resources. Combining both methods allows for scalability in fault simulation, making it suitable for both small and large IC designs.

Flexibility and adaptability involve selective detailed analysis and adaptive workflow. After a broad concurrent fault simulation, specific faults that are complex or critical can be further analyzed using serial fault simulation, providing flexibility in the testing process. The combination allows for an adaptable workflow where the initial phase is rapid and broad, and the subsequent phase is detailed and focused.

Improved fault detection involves comprehensive fault detection and early identification and debugging. By using concurrent simulation to cover many faults quickly and serial fault simulation to ensure faults hitting limitations are handled, the overall fault detection capability is enhanced. Early identification of potential faults with concurrent simulation allows for timely debugging and fixing, while serial fault simulation ensures that no critical faults are overlooked before final production.

Cost-effective testing includes reduced testing time and cost, and minimized risk of undetected faults. The combination reduces the overall time demanded of fault simulation, leading to cost savings in the IC design and testing process. By ensuring thorough testing through both methods, the risk of undetected faults is minimized, reducing potential costs associated with post-production failures.

Process optimization includes iterative improvement and parallel testing capabilities. The results from concurrent simulation can guide the focus of serial simulation, creating an iterative process that continuously improves fault detection and analysis. Parts of the IC design can undergo concurrent fault simulation while critical components are simultaneously tested using serial fault simulation, optimizing the overall testing workflow.

In summary, combining serial and concurrent fault simulation allows for a more robust, efficient, and effective approach to fault detection in IC design, providing the benefits of both methods while mitigating their individual limitations. The example embodiments provide for a method and system for combining serial fault simulation and concurrent fault simulation. All the faults are initially processed using a concurrent fault simulation. When a specific fault of all the faults reaches a limitation, such as a programming language interface (PLI) call, a new simulation process is created. The new simulation process is a single fault simulation process. The identified fault is discarded from the concurrent fault simulation and switched to the single fault simulation. The concurrent fault simulation does not experience any interruptions by the switch-over. The identified fault is processed by the new single fault simulation until the fault is detected. Once the fault in the single fault simulation is detected and the faults of the concurrent fault simulation are detected, the results are combined and provided to a user for further processing.

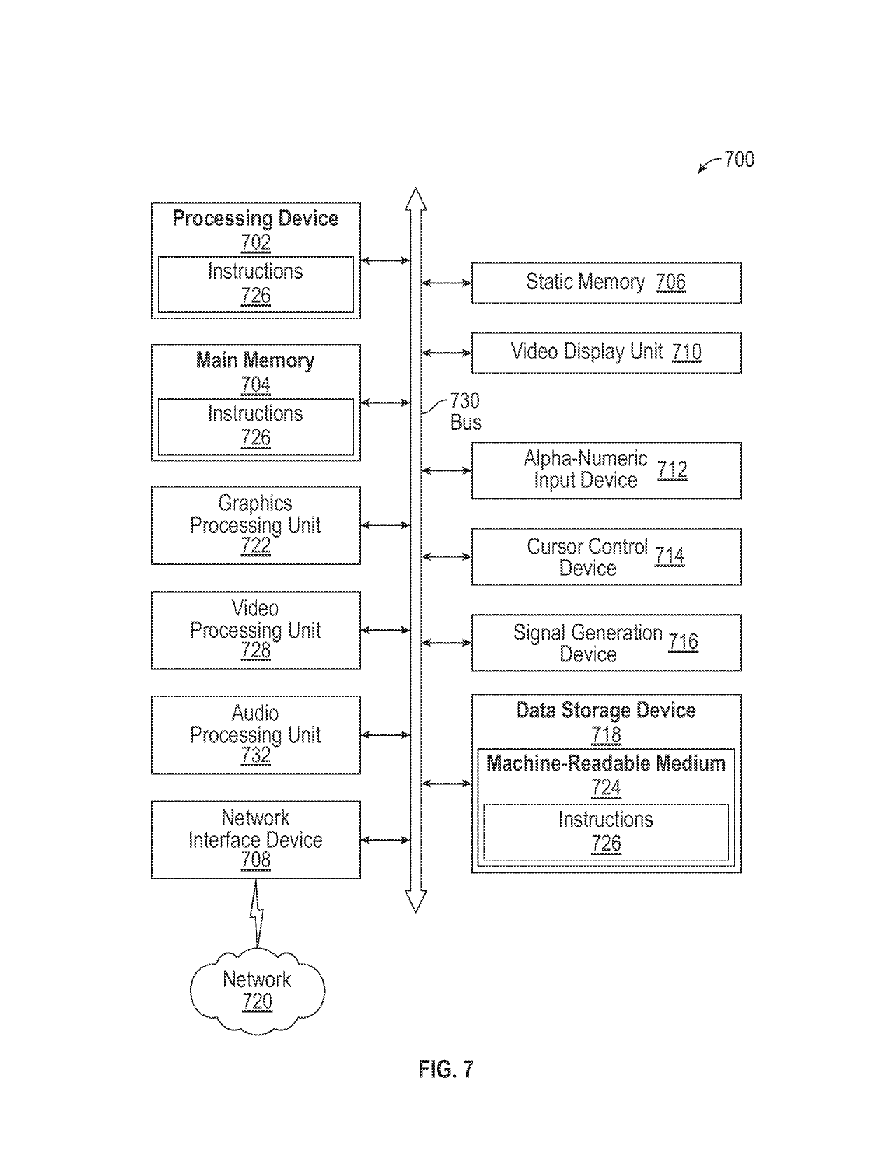

FIG. 7 illustrates an example computer system in which embodiments of the present disclosure may operate.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a local area network (LAN), an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term "machine" shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. The processing device 702 may be an integrated circuit (IC) including a plurality of functional blocks, each comprising circuitry to execute tasks. The functional blocks may be processors, microprocessors, system on chips (SoCs), memory ICs, power management ICs, communication ICs, and/or mixed-signal ICs. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term "machine-readable storage medium" should be taken to include a single medium or multiple media (e.g., a centralized or distributed database, and/or associated caches and servers) that store the one or more sets of instructions. The term "machine-readable storage medium" shall also be taken to include any medium that is capable of storing or encoding a set of instructions for execution by the machine and that cause the machine and the processing device 702 to perform any one or more of the methodologies of the present disclosure. The term "machine-readable storage medium" shall accordingly be taken to include, but not be limited to, solid-state memories, optical media, and magnetic media.

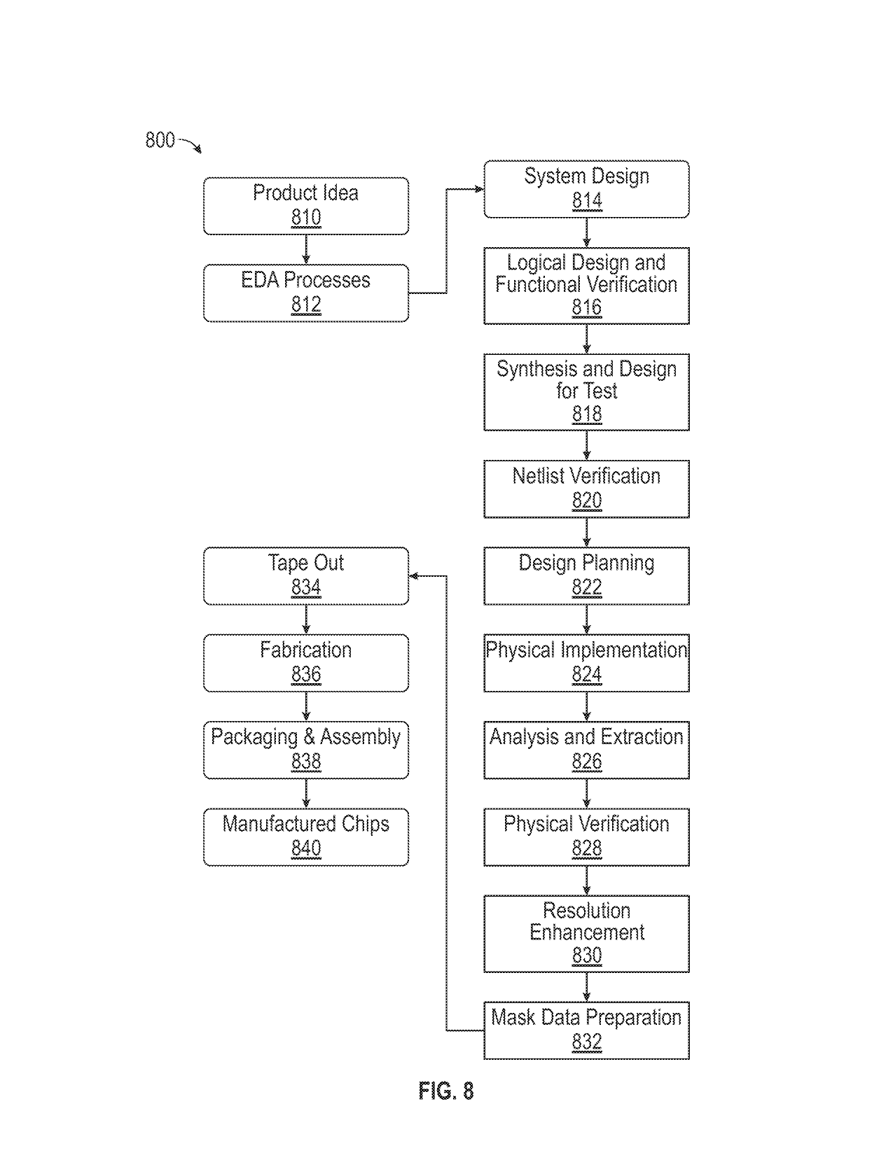

FIG. 8 illustrates an example set of processes 800 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 810 with information supplied by a designer, information which is transformed to create an article of manufacture that uses a set of EDA processes 812. When the design is finalized, the design is taped-out 834, which is when artwork (e.g., geometric patterns) for the integrated circuit is sent to a fabrication facility to manufacture the mask set, which is then used to manufacture the integrated circuit. After tape-out, a semiconductor die is fabricated 836 and packaging and assembly processes 838 are performed to produce the finished integrated circuit 840.

Specifications for a circuit or electronic structure may range from low-level transistor material layouts to high-level description languages. A high-level representation may be used to design circuits and systems, using a hardware description language (‘HDL’) such as VHDL, Verilog, SystemVerilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding tools of that layer (e.g., a formal verification tool). The processes described by be enabled by EDA products (or tools).

During system design 814, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 816, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 818, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 820, the netlist is checked for compliance with timing constraints and for correspondence with the HDL code. During design planning 822, an overall floor plan for the integrated circuit is constructed and analyzed for timing and top-level routing.

During layout or physical implementation 824, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flip-flop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 826, the circuit function is verified at the layout level, which permits refinement of the layout design. During physical verification 828, the layout design is checked to ensure that manufacturing constraints are correct, such as DRC constraints, electrical constraints, lithographic constraints, and that circuitry function matches the HDL design specification. During resolution enhancement 830, the geometry of the layout is transformed to improve how the circuit design is manufactured.

During tape-out, data is created to be used (after lithographic enhancements are applied if appropriate) for production of lithography masks. During mask data preparation 832, the ‘tape-out’ data is used to produce lithography masks that are used to produce finished integrated circuits.

A storage subsystem of a computer system may be used to store the programs and data structures that are used by some or all of the EDA products described herein, and products used for development of cells for the library and for physical and logical design that use the library.

The present disclosure presents systems and methods for combining serial fault simulation and concurrent fault simulation to reduce computational processing.

In one example, a non-transitory computer-readable medium for storing instructions is provided that, when executed by a processor, cause the processor to perform fault simulation by initiating a concurrent fault simulation for a plurality of faults injected into an IC model, identifying at least one fault of the plurality of faults that is unable to be implemented by the concurrent fault simulation, initiating a single fault simulation to process the at least one fault unable to be implemented by the concurrent fault simulation without interrupting the concurrent fault simulation from processing other faults of the plurality of faults, discarding the at least one fault from the concurrent fault simulation, and combining or providing fault results from the concurrent fault simulation and the single fault simulation upon completion of both the concurrent fault simulation and the single fault simulation.

In another example, a system includes a memory and a processor, operatively coupled to the memory, to simultaneously perform concurrent fault simulation and single fault simulation by initiating the concurrent fault simulation for a plurality of faults injected into an IC model, identifying multiple faults of the plurality of faults unable to be implemented by the concurrent fault simulation, initiating a single fault simulation for each of the multiple faults unable to be implemented by the concurrent fault simulation without interrupting the concurrent fault simulation, wherein each of the multiple faults inherits its processing state from a respective point of transition, and discarding the multiple faults from the concurrent fault simulation when the multiple faults transition into respective single fault simulations.

In yet another example, a method includes initiating a concurrent fault simulation for a plurality of faults injected into an IC model, identifying at least one fault of the plurality of faults that is unable to be implemented by the concurrent fault simulation, initiating, by a processing device, a single fault simulation to process the at least one fault unable to be implemented by the concurrent fault simulation without interrupting the concurrent fault simulation from processing other faults of the plurality of faults, discarding the at least one fault from the concurrent fault simulation, and combining fault results from the concurrent fault simulation and the single fault simulation upon completion of both the concurrent fault simulation and the single fault simulation.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory ("ROM"), random access memory ("RAM"), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementation of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A non-transitory computer-readable medium storing instructions that, when executed by a processor, cause the processor to:
initiate a concurrent fault simulation for a plurality of faults injected into an IC model;
identify at least one fault of the plurality of faults that is unable to be implemented by the concurrent fault simulation;
initiate a single fault simulation to process the at least one fault unable to be implemented by the concurrent fault simulation without interrupting the concurrent fault simulation from processing other faults of the plurality of faults;
discard the at least one fault from the concurrent fault simulation; and
provide fault results from the concurrent fault simulation and the single fault simulation upon completion of both the concurrent fault simulation and the single fault simulation.

2. The non-transitory computer-readable medium of claim 1, wherein the least one fault of the plurality of faults is unable to be implemented by the concurrent fault simulation due to encountering a call function.

3. The non-transitory computer-readable medium of claim 1, wherein the single fault simulation is initiated using a copy process.

4. The non-transitory computer-readable medium of claim 1, wherein a cone of impact is generated for each of the plurality of faults when the plurality of faults are injected into the IC model.

5. The non-transitory computer-readable medium of claim 4, wherein the cone of impact of at least some of the plurality of faults is terminated when the respective fault is detected.

6. The non-transitory computer-readable medium of claim 1, wherein, when the at least one fault transitions from the concurrent fault simulation to the single fault simulation, the at least one fault inherits its processing state from a point of transition.

7. The non-transitory computer-readable medium of claim 1, wherein, when the at least one fault transitions from the concurrent fault simulation to the single fault simulation, the at least one fault is not re-processed from a point of injection into the IC model.

8. The non-transitory computer-readable medium of claim 1, wherein the single fault simulation that processes the at least one fault is terminated when the at least one fault is detected while the concurrent fault simulation continues.

9. A system comprising:
a memory; and
a processor, operatively coupled to the memory, to:
initiate the concurrent fault simulation for a plurality of faults injected into an IC model;
identify multiple faults of the plurality of faults unable to be implemented by the concurrent fault simulation;
initiate a single fault simulation for each of the multiple faults unable to be implemented by the concurrent fault simulation without interrupting the concurrent fault simulation, wherein each of the multiple faults inherits its processing state from a respective point of transition; and
discard the multiple faults from the concurrent fault simulation when the multiple faults transition into respective single fault simulations.

10. The system of claim 9, wherein fault results from the concurrent fault simulation and the single fault simulation for each of the multiple faults are combined upon completion of both the concurrent fault simulation and the single fault simulation for each of the multiple faults.

11. The system of claim 9, wherein at least some of the multiple faults are unable to be implemented by the concurrent fault simulation due to encountering a call function.

12. The system of claim 9, wherein the single fault simulation for each of the multiple faults unable to be implemented by the concurrent fault simulation is initiated using a copy process.

13. The system of claim 9, wherein, when the multiple faults transition from the concurrent fault simulation to a respective single fault simulation, the multiple faults are not re-processed from a point of injection into the IC model.

14. The system of claim 9, wherein the single fault simulation for each of the multiple faults unable to be implemented by the concurrent fault is terminated when the multiple faults are detected or when an allotted time is reached.

15. A method comprising:
initiating a concurrent fault simulation for a plurality of faults injected into an IC model;
identifying at least one fault of the plurality of faults that is unable to be implemented by the concurrent fault simulation;
initiating, by a processing device, a single fault simulation to process the at least one fault unable to be implemented by the concurrent fault simulation without interrupting the concurrent fault simulation from processing other faults of the plurality of faults;
discarding the at least one fault from the concurrent fault simulation; and
combining fault results from the concurrent fault simulation and the single fault simulation upon completion of both the concurrent fault simulation and the single fault simulation.

16. The method of claim 15, wherein the least one fault of the plurality of faults is unable to be implemented by the concurrent fault simulation due to encountering a call function.

17. The method of claim 15, wherein the single fault simulation is initiated using a copy process.

18. The method of claim 15, wherein a cone of impact is generated for each of the plurality of faults when the plurality of faults are injected into the IC model.

19. The method of claim 15, wherein, when the at least one fault transitions from the concurrent fault simulation to the single fault simulation, the at least one fault inherits its processing state from a point of transition.

20. The method of claim 15, wherein, when the at least one fault transitions from the concurrent fault simulation to the single fault simulation, the at least one fault is not re-processed from a point of injection into the IC model.
